(19) United States
(12) Patent Application Publication
(10) Pub. No.: US 2017/0329407 A1
(43) Pub. Date: Nov. 16, 2017

(54) COMBINED INPUT AND OUTPUT DEVICE AND METHOD FOR OPERATING AN INPUT AND OUTPUT DEVICE

(71) Applicants: Alexander van Laack, Aachen (DE); Bertrand Stelandre, Thimister (BE); Dirk Nolten, Kreuzau (DE)

(72) Inventors: Alexander van Laack, Aachen (DE); Bertrand Stelandre, Thimister (BE); Dirk Nolten, Kreuzau (DE)

(21) Appl. No.: 15/593,783

(22) Filed: May 12, 2017

(30) Foreign Application Priority Data
May 13, 2016 (DE) 10 2016 108 899.4

(51) Int. Cl. G06F 3/01; G06F 3/02; G06F 3/041

(52) U.S. Cl. CPC G06F 3/016; G06F 3/0416; G06F 3/02; G06F 3/0414

(57) ABSTRACT

The disclosure relates to a combined input and output device including a screen for displaying at least one operating element, a touchscreen arranged above screen, for detecting a position of a contact with the operating surface of the touchscreen, and a frame. The screen is arranged under the touchscreen in frame, and, on the frame, a plurality of mini switches are arranged, on which the touchscreen rests.

### CROSS-REFERENCE TO RELATED APPLICATION

This U.S. Patent Application claims priority to German Patent Application No. 10 2016 108 899.4, filed May 13, 2016, entitled “Combined input and output device and method for operating an input and output device,” the entire disclosure of the application being considered part of the disclosure of this application and hereby incorporated by reference.

### BACKGROUND

Touchscreens (touch-sensitive screens) are used in numerous products, for example, in screens of smartphones, computers, or in displays for controlling and regulating devices located in a vehicle. For this purpose, on a screen, applications or operating elements are displayed, which can be shifted, enlarged or reduced, or selected/executed by the user.

Known touchscreens do not allow separation of selection and execution of an operating element; thus, the selection of an operating element occurs via the touchscreen by sliding or swiping the finger of a user, and the selection or execution of the application or of the operating element occurs by tapping on the operating element. In particular, in displays in vehicles, the strain on the user is increased as a result, when he/she operates the touchscreen while driving.

Haptic touchscreens are capable of providing the user haptic feedback, which normally are generated by a high-frequency vibration. However, this feedback is generated only after the user has run the application or activated the control panel. Therefore, a haptic feedback is only a confirmation and not an assistance in the selection.

In WO 2006/074712 A2, an input device with a touchscreen and a force sensor is described, in which, by touching a control panel of the touchscreen or by pressing on a control panel of the touchscreen in the area of the display of the operating element, a warning is generated.

### SUMMARY

The aspects disclosed herein relate to a combined input and output device comprising a screen for displaying at least one operating element, for detecting a position of a contact with the operating surface of the touchscreen, and a frame.

The aspects disclosed herein further relate to a method for operating an input and output device comprising a touchscreen arranged in a frame.

Advantages of the aspects disclosed herein are achieved by a (haptic) combined input and output device of the type described above, in which the display is arranged under the touchscreen in the frame and a plurality of mini switches are arranged on the frame on which the touchscreen rests.

The screen is used for displaying at least one operating element or application/software application.

The frame can also be formed by the housing of an electrical device or by a surface, for example, the surface of a dashboard of a vehicle, in which the touchscreen is arranged, so that the frame is at the same time also the housing or the surface in which the touchscreen is arranged.

The touchscreen preferably comprises a touch plate and a touch sensor.

Such an input and output device enables a separation of selection and execution. What is achieved thereby is that mini switches are arranged under a transparent touch plate. Such an arrangement provides the user with haptic feedback.

As a result of the touch plate being much lighter than the screen itself, a small movement during the clicking is made possible, even in the case of larger touchscreens.

By actuation of the mini switch, preferably a haptic signal can be output/sensed. If the user actuates the touchscreen in a manner in which the user increases the pressure on the touchscreen, in order to start an application or to activate a control panel, a haptic signal/feedback is generated.

A suitable mini switch, which upon actuation generates a haptic signal due to the pressing of the switch (“clicking”), has small installation dimensions.

In a preferred embodiment, the touch surface of the touchscreen rests on the mini switches. In this embodiment, the mini switches are arranged between the frame and the touch surface.

In another preferred embodiment of the invention, the touch sensor of the touchscreen rests on the mini switches. In this embodiment, the mini switches are arranged between the frame and the touch sensor.

Preferably, an insulation which protects the device from being soiled is arranged between the touch surface or touch sensor and the frame.

Preferably, on one side of the frame, mini switches are arranged, and, on the opposing side to this side, one or more connecting elements are arranged, wherein one side of the touchscreen rests on the mini switches, and the opposing side of the touchscreen rests on a connecting element or several connecting elements. Such an embodiment enables a different haptic feedback, since the touchscreen cannot be depressed in all directions by pressure, as is the case in an embodiment in which the mini switches are arranged on all sides of the frame, instead it yields to pressure on only one side, while the other side, on which one or more connecting elements are arranged, does not yield.

The aspects disclosed herein provide a method of the type described above, in which, due to contact with the touchscreen of the input and output device, a first signal for the detection of the position of a contact with an operating surface of the touchscreen is generated, and, due to pressure on the touchscreen of the input and output device, a second signal is generated, wherein the touchscreen is mounted on mini switches, by means of which the pressure exerted and the position on the touchscreen are detected.

In this method, the x, y coordinates of the fingers that contact the surface of the touchscreen or the touch plate thereof are determined, and, as soon as one of the mini switches is clicked, the selected control panel is executed.

The first and the second signals are preferably processed by a processor, whereby a control command associated with an operating element is generated, in order to control or regulate devices which are connected to the input and output device.

Upon generating pressure on the touchscreen, for example, due to an increased pressure of the finger of a user on the touchscreen, or due to the tapping/clicking of an application or of an operating element which is displayed on the touchscreen, preferably a haptic feedback is generated. The clicking sensation is very natural, since it is generated by the use of the mini switches.

Moreover, the object of the present invention is achieved by use of the input and output device according to the invention and the method according to the invention for controlling and regulating one or more devices of a vehicle, such as, for example, a motor vehicle, aircraft or rail vehicle.

### BRIEF DESCRIPTION OF DRAWINGS

Further details, features and advantages of implementations of the invention result from the following description of exemplary embodiments by reference to the associated figures.

FIG. 1 shows an exploded view of a first embodiment of an input and output device according to the disclosure,

FIG. 2 shows an exploded view of a second embodiment of an input and output device according to the disclosure,

FIG. 3 shows an exploded view of a third embodiment of an input and output device according to the disclosure,

FIGS. 4(a)-(c) show a cross section through the embodiments of the input and output devices shown in FIGS. 1 to 3,

FIG. 5 shows a partial cross-sectional view of an input and output device,

FIG. 6 shows an exploded view of a fourth embodiment of an input and output device according to the disclosure, and

FIG. 7 shows a schematic representation of a method for actuating an input and output device according to the disclosure.

### DETAILED DESCRIPTION

In FIGS. 1 to 3, different embodiments of an input and output device 1 are illustrated.

FIG. 1 shows an input and output device 1 which comprises a screen 2 for displaying operating elements or information such as, for example, parameters of devices connected to the input and output device. Moreover, via a touchscreen, for example, a capacitive touchscreen, applications or operating elements displayed on screen 2 can be selected. This occurs by contact with a (glass/transparent) touch plate 3.

As shown in FIG. 1, screen 2 is arranged in a fixed frame 4, which at the same time can also be a housing or a portion of a dashboard of a vehicle. With respect to screen 2 frame 4 forms a level area on which a plurality of mini switches 5 are arranged, wherein, in the embodiment shown in FIG. 1, the mini switches 5 are distributed on frame 4.

In FIG. 1, eleven mini switches are displayed; it is understood that the input and output device 1 according to the invention can also have more or fewer mini switches 5.

Mini switches 5 are arranged on frame 4 so that the edges of touch plate 3 rest on mini switches 5, so that, when pressure is exerted on touch plate 3, mini switches 5 are pressed/actuated. Which mini switches 5 are actuated depends on where the touch plate 3 is pressed, so that, by means of the mini switches 5 actuated in this manner, the position of the pressure point on touch plate 3 can also be determined. This occurs by means of a processor (not shown in the figures) connected to the input and output device 1.

A (laminated) touch sensor 6 is arranged between screen 2 and touch plate 3, under touch plate 3. The touch sensor 6 is dimensioned smaller than the touch plate 3, so that mini switches 5 are arranged laterally around touch sensor 6.

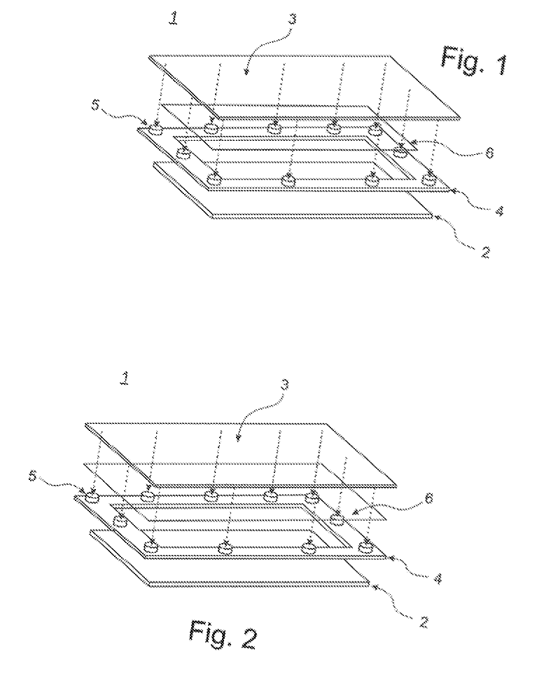

The second embodiment of the input and output device 1 shown in FIG. 2 differs from the one shown in FIG. 1 in that touch plate 3 has the same dimensioning of the area as touch sensor 6, so that touch sensor 6 of the touchscreen, and not the touch plate 3, rests on the mini switches 5.

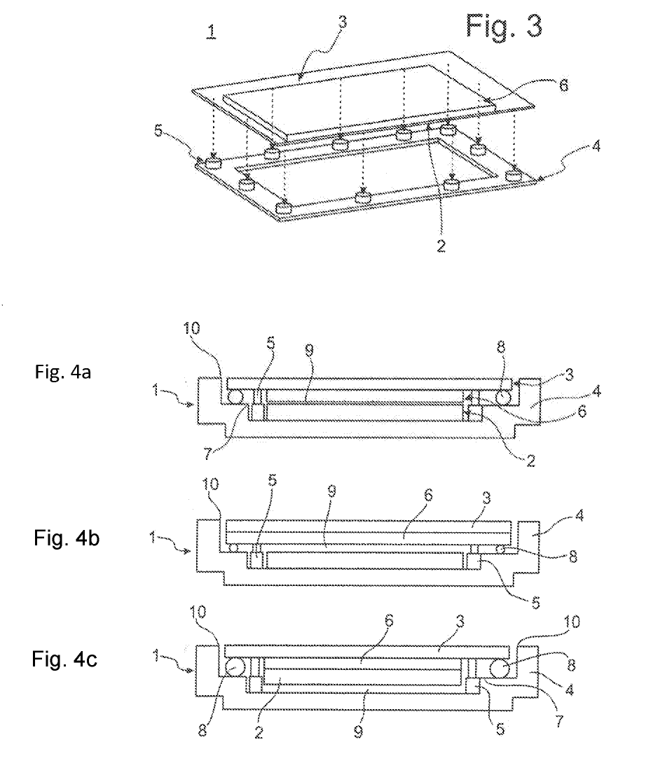

The third embodiment of input and output device 1 shown in FIG. 3 corresponds to the first embodiment shown in FIG. 1, except for the arrangement of touch sensor 6 and of screen 2, which, in the embodiment shown in FIG. 3, is arranged immediately under touch plate 3, wherein touch sensor 6 and screen 2 are dimensioned smaller than touch plate 3, so that mini switches 5 extend laterally past the outer edges of touch sensor 6 and of screen 2, so that touch plate 3 rests on mini switches 5 which are arranged on the frame 4.

In FIGS. 4(a)-(c), cross sections of the three embodiments of input and output device 1 shown in FIGS. 1 to 3 are illustrated.

FIG. 4a shows the first embodiment of input and output device 1 shown in FIG. 1, in which screen 2 is arranged in frame 4 and mini switches 5 are arranged about screen 2. Frame 4 has a first edge 7 which is in one plane with the surface of the screen. Insulation 8 is arranged on this first edge 7, which protects the device from being soiled, in that it seals the area between first edge 7 of frame 4 and touch plate 3. Insulation 8 is designed to be flexible, so that it does not influence the movement of touch plate 3, when pressure is applied to touch plate 3. In addition, there is a gap 9 between touch sensor 6 arranged under the touch plate 3, and the surface of screen 2, which enables the touchscreen to be moved in the direction of screen 2 when pressure is applied to touch plate 3.

Moreover, frame 4 or the housing has a second edge 10 which lies in the same plane as touch plate 3.

In the second embodiment of input and output device 1, which is illustrated in FIG. 4b, insulation 8 is dimensioned smaller, since touch sensor 6 rests on mini switches 5, and thus the distance between first edge 7 of frame 4 and the bottom side of touch sensor 6 is also smaller.

In the third embodiment of input and output device 1, which is illustrated in FIG. 4c, screen 2 is arranged under touch sensor 6, so that gap 9 is formed under screen 2.

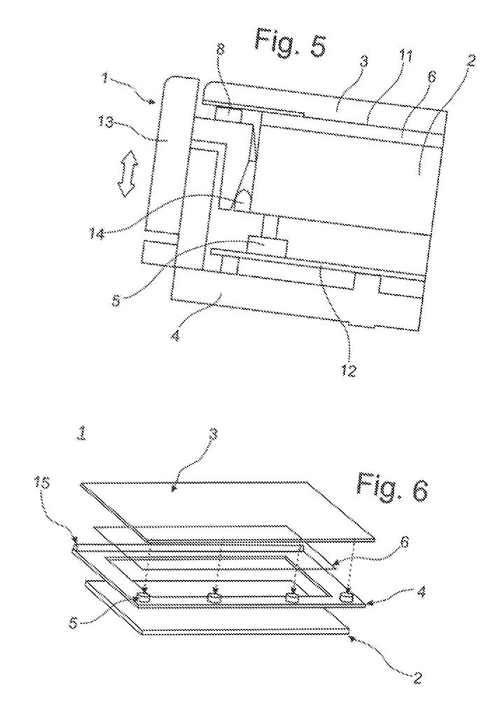

In FIG. 5, a portion of a cross section of an embodiment of input and output device 1 is illustrated, in which screen 2 is arranged immediately under touch plate 3 (of a glass lens) and joined with adhesive 11 (LOCA: liquid optical clear adhesive). Mini switches 5 are arranged on frame 4, wherein a printed wire board (PWB) 12 with mini switches 5 on it is positioned between mini switch 5 and frame 4.

In the embodiment shown in FIG. 5, frame 4 has a composite frame 13 (or a guide for screen 2), which is movably connected to the rest of frame 4 (in the direction of the arrow), so that composite frame 13, which is connected to screen 2, for example, with adhesive 14, is movably arranged in frame 4.

By pressure on the touchscreen, screen 2 is lowered with composite frame 13, so that mini switches 5, which are connected via printed wire board 12 to the processor, are actuated.

An insulation 8 or a spacer, for example, an acrylic adhesive (PSA) is arranged between composite frame 13 and touch plate 3.

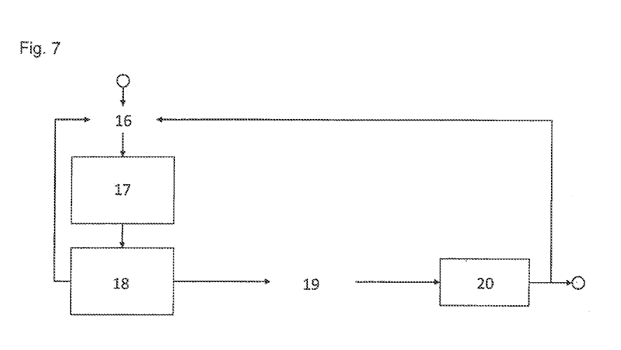

In FIG. 6, another embodiment of input and output device 1 is illustrated, in which mini switches 5 are arranged on only one side of frame 4, and wherein a connecting element 15 is arranged on the opposing side so that the touchscreen or, as in the embodiment shown in FIG. 6, the touch plate 3, is held firmly on one side by connecting element 15, while, on the other side, it can be tilted by pressure on the touchscreen and thus on mini switches 5.

In FIG. 7, the operation of input and output device 1 is illustrated schematically.

By contacting 16 the touchscreen, the position of the fingers on surface 17 and thus the selection of a software icon 18 (or of an application or a control panel) is determined. By a physical click 19 (by clicking on the icon), the software is executed 20 (the application is executed or the operating element is activated, respectively).

1. A combined input and output device comprising
a screen for displaying at least one operating element,
a touchscreen arranged over the screen, for detecting a position of contact with an operating surface of the touchscreen, and
a frame to support the touchscreen,
a plurality of mini switches arranged on the frame,
wherein screen is arranged under the touchscreen in the frame, and,
on frame, a plurality of mini switches are arranged so that the touchscreen is in contact with the plurality of mini switches.

2. The input and output device according to claim 1, wherein a haptic signal can be output by actuation of mini switches.

3. The input and output device according to claim 1, wherein the touchscreen comprises a touch surface and a touch sensor.

4. The input and output device according to claim 3, wherein touch surface of the touchscreen rests on mini switches.

5. The input and output device according to claim 3, wherein a touch sensor of the touchscreen rests on mini switches.

6. The input and output device according to claim 3, wherein an insulation is arranged between touch surface or touch sensor and frame.

7. The input and output device according to claim 1, wherein the plurality of mini switches are arranged on one side of frame and on the opposing side of the frame one or more connecting elements are arranged.

8. A method for operating an input and output device, comprising:
providing a touchscreen arranged in a frame;
detecting a contact of the touchscreen, and in response to the detecting of the contact, generating a first signal including the position of the contact;
detecting pressure on the touchscreen of input and output device, and in response to the detecting of pressure, generating a second signal,
wherein the touchscreen is supported by mini switches to detect at least the pressure and the position.

9. The method according to claim 8, wherein the first and the second signals are processed by a processor.

10. The method according to claim 8, wherein a haptic feedback is generated upon generating pressure on the touchscreen.
